(19) United States
(12) Patent Application Publication
(10) Pub. No.: US 2025/0162173 A1
(43) Pub. Date: May 22, 2025

(54) TOOL EXCHANGE DEVICE, COUPLING UNIT, AND MODULE UNIT

(71) Applicant: NITTA CORPORATION, Osaka-shi, Osaka (JP)

(72) Inventors: Kenta MATSUOKA, Nabari-shi, Mie (JP); Ryosuke MATSUMOTO, Nabari-shi, Mie (JP); Hiroki KIKUCHI, Nabari-shi, Mie (JP)

(21) Appl. No.: 18/839,541

(22) PCT Filed: Apr. 21, 2023
(86) PCT No.: PCT/JP2023/015954

§ 371 Date: Aug. 19, 2024

(30) Foreign Application Priority Data
May 30, 2022 (JP) 2022-088022

(51) Int. Cl. B25J 15/04

(52) U.S. Cl. CPC B25J 15/04

(57) ABSTRACT

A tool exchange device includes: a module attachment portion provided on a coupling unit body of at least one of the first coupling unit and the second coupling unit; and a module unit provided with a connector and detachably attached to the coupling unit body via the module attachment portion. The module attachment portion includes a first fitting portion having a projecting cross section or a recessed cross section. The module unit includes a second fitting portion having a recessed cross section or a projecting cross section, and is fixed to the coupling unit body by the first fitting portion or the second fitting portion having the recessed cross section sandwiching the second fitting portion or the first fitting portion having the projecting cross section in a thickness direction and making a plurality of pins penetrate the first fitting portion and the second fitting portion.

### FIELD

The present invention relates to a tool exchange device, a coupling unit, and a module unit.

### BACKGROUND ART

For example, as a tool exchange device to be applied to an industrial robot, a device including a first coupling unit attached to a robot body side and a second coupling unit attached to a tool side is disclosed (for example, Patent Literature 1). In such a tool exchange device, upon a cam of a projection portion provided on a coupling surface of the first coupling unit being engaged with an engaging member on an inner surface of a coupling hole provided in a coupling surface of the second coupling unit in a state where the projection portion is inserted into the coupling hole, and the coupling surfaces are in contact with each other, the first coupling unit and the second coupling unit are coupled.

In the tool exchange device, a detachable module unit is attached in accordance with the purpose of use of a robot or the type of a tool, and for example, a cable or a tube from a robot body is connected to the tool via the module unit. In this manner, in the tool exchange device, the cable, the tube, or the like is connected to the robot body and the tool using the module unit, and for example, electricity, water, or air is supplied from the robot body side to the tool side via the module unit.

Here, FIG. 6 is a schematic view illustrating an attachment structure for attaching a module unit 104 to a coupling unit 100 in a tool exchange device in the related art. In FIG. 6, either the first coupling unit or the second coupling unit of the tool exchange device is illustrated as the coupling unit 100. As illustrated in FIG. 6, in the coupling unit 100, a module attachment portion 102 is provided on a side surface 101a of a coupling unit body 101, and the module unit 104 is detachably attached to the module attachment portion 102. In the coupling unit 100, the first coupling surface 20 comes into contact with one coupling unit (not illustrated), and a positioning pin 28 is positioned by being inserted into a hole provided corresponding to the one coupling unit.

The module attachment portion 102 is formed with a plate-shaped cantilever projecting portion 105 extending in a circumferential direction on the side surface 101a of the coupling unit body 101, and a coupling unit-side stepped portion 106 that forms a step having an L-shaped cross section with the cantilever projecting portion 105. The cantilever projecting portion 105 is formed with a positioning through hole 115 for positioning the module unit 104 and a threaded hole 113 into which a bolt 110 inserted through the module unit 104 is screwed, so as to penetrate a thickness.

The module unit 104 includes a rectangular module unit body 109 having a predetermined thickness, and a connector 61 to which a cable or a tube is connected is provided on one side surface of the module unit body 109. In addition, in the module unit body 109, a module unit-side stepped portion 120 having a step-shaped cross section to which the module attachment portion 102 may be detachably attached is formed on a surface 109a illustrated as a lower surface in FIG. 6. The module unit body 109 is bored with a plurality of through holes 112 penetrating the thickness in a formation region of the module unit-side stepped portion 120, and a positioning pin 121 fitted into the positioning through hole 115 of the module attachment portion 102.

When being attached to the module attachment portion 102 of the coupling unit 100, the module unit 104 is placed in a cantilever state so that the module unit-side stepped portion 120 of the module unit 104 is engaged with the cantilever projecting portion 105 of the module attachment portion 102. At this time, the positioning pin 121 provided in the formation region of the module unit-side stepped portion 120 is fitted into the positioning through hole 115 formed in the cantilever projecting portion 105, so that the module unit 104 is positioned accurately with respect to the module attachment portion 102 and is temporarily fixed in the cantilever state.

Next, in this state, the bolt 110 penetrates the threaded hole 113 of the cantilever projecting portion 105 from the through hole 112 formed in the module unit 104, and the bolt 110 is screwed into the threaded hole 113 of the cantilever projecting portion 105. Accordingly, the module unit 104 is fixed, with a cantilever structure, on the cantilever projecting portion 105 of the module attachment portion 102.

### CITATION LIST

### Patent Literature

Patent Literature 1: JPH05-16994B

### SUMMARY OF INVENTION

### Technical Problem

In a case where such a tool exchange device to which the module unit 104 is attached is attached to a robot, a cable or a tube connected to the connector 61 of the module unit 104 may interfere with a peripheral device when the robot operates, and an external load may be applied to the module unit 104. In this case, since the module unit 104 is held on the cantilever projecting portion 105 in a cantilever structure in the module attachment portion 102, there are problems that a load to be applied to the cantilever projecting portion 105 is large, and the cantilever projecting portion 105 which is a fixing portion of the module unit 104 is damaged by an external load.

In addition, when the module unit 104 is fixed onto the plate-shaped cantilever projecting portion 105 of the module attachment portion 102, it is necessary to increase a surface area of the cantilever projecting portion 105 on which the module unit 104 is placed so as to withstand the weight of the module unit 104, and therefore, there is a problem that the module attachment portion 102 is increased in size. In this manner, in a case where the module attachment portion 102 is increased in size, there are problems that the module unit 104 fixed to the module attachment portion 102 is accordingly increased in size, and the module unit 104 interferes with a peripheral device when being used for a robot that performs work in a narrow space. In addition, an increase in weight due to an increase in size of the module unit 104 may exceed a load capacity usable in the robot. Therefore, it is desired to reduce the size of the module unit 104.

The present invention has been made in view of the above points, and an object thereof is to provide a tool exchange device, a coupling unit, and a module unit capable of suppressing damage to a fixed portion due to an external load when the module unit is fixed to a module attachment portion of a coupling unit body as compared with the related art, and capable of reducing the size of the module unit.

### Solution to Problem

A tool exchange device according to the present invention is a tool exchange device including a first coupling unit to be attached to either a body side or a tool side of an apparatus; a second coupling unit to be attached to the other of the body side and the tool side and configured to be coupled to the first coupling unit; a module attachment portion provided on a side surface of a coupling unit body of at least one of the first coupling unit and the second coupling unit; and a module unit provided with a connector to which a cable or a tube is connectable and detachably attached to the side surface of the coupling unit body via the module attachment portion, in which the module attachment portion includes a first fitting portion having a projecting cross section or a recessed cross section and extending in a circumferential direction along the side surface of the coupling unit body, and the module unit includes a second fitting portion having a recessed cross section or a projecting cross section configured to be fitted into the first fitting portion, and is fixed to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and making a plurality of pins penetrate the first fitting portion and the second fitting portion which are fitted into each other.

A coupling unit according to the present disclosure is a coupling unit of a tool exchange device, the coupling unit having a configuration capable of being coupled to a coupling unit to be attached to either a body side or a tool side of an apparatus, and being to be attached to the other of the body side and the tool side, the coupling unit including a coupling unit body; and a module attachment portion provided on a side surface of the coupling unit body and configured to detachably attach, to the side surface of the coupling unit body, a module unit provided with a connector to which a cable or a tube is connectable, in which the module attachment portion includes a first fitting portion having a projecting cross section or a recessed cross section and extending in a circumferential direction along the side surface of the coupling unit body, the first fitting portion having a configuration capable of being fitted into a second fitting portion having a recessed cross section or a projecting cross section and provided in the module unit, and the module attachment portion fixes the module unit to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and a plurality of pins penetrating the first fitting portion and the second fitting portion which are fitted into each other.

A module unit according to the present invention is a module unit of a tool exchange device that includes a first coupling unit to be attached to either a body side or a tool side of an apparatus and a second coupling unit to be attached to the other of the body side and the tool side and configured to be coupled to the first coupling unit, the module unit being detachably attached to a side surface of a coupling unit body of at least one of the first coupling unit and the second coupling unit, the module unit including: a module unit body detachably attached to the side surface of the coupling unit body via a module attachment portion provided on the side surface of the coupling unit body and provided with a connector to which a cable or a tube is connectable, in which the module unit body includes a second fitting portion having a projecting cross section or a recessed cross section that is fittable with respect to a first fitting portion having a projecting cross section or a recessed cross section, the first fitting portion being provided on the module attachment portion and extending in a circumferential direction along the side surface of the coupling unit body, and the module unit body is fixed to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and a plurality of pins penetrating the first fitting portion and the second fitting portion which are fitted into each other.

### Advantageous Effects of Invention

According to the present invention, the coupling unit body and the module unit can be firmly fixed to each other by sandwiching the first fitting portion and the second fitting portion in the thickness direction, and therefore, it is possible to suppress damage to a fixing portion due to an external load as compared with the related art when the module unit is fixed to the coupling unit body. In addition, the module unit fixed to the module attachment portion of the coupling unit body can be reduced in size by sandwiching the first fitting portion and the second fitting portion in the thickness direction.

### BRIEF DESCRIPTION OF DRAWINGS

FIG. 1 is a schematic view illustrating an overall configuration of an industrial robot to which a tool exchange device according to the present embodiment is applied.

FIG. 2 is a schematic view illustrating a configuration when a module unit is attached to a coupling unit.

FIG. 3 is a schematic view illustrating a configuration when the module unit is detached from the coupling unit.

FIG. 4 is a cross-sectional view illustrating a cross-sectional configuration taken along a line A-A′ in FIG. 2.

FIG. 5 is a graph illustrating results of a rigidity test.

FIG. 6 is a schematic view illustrating an attachment structure for attaching a module unit to a coupling unit in a tool exchange device in the related art.

### DESCRIPTION OF EMBODIMENTS

Hereinafter, an embodiment of the present invention will be described in detail with reference to the drawings. In the following description, the same components are denoted by the same reference numerals, and overlapping description is omitted.

### (1) Configuration of Industrial Robot to Which Tool Exchange Device is Applied

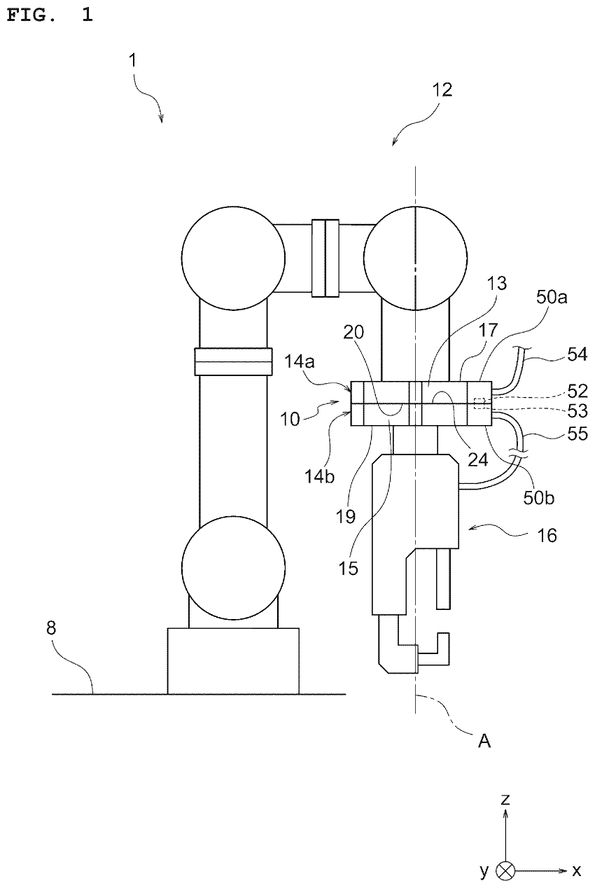

FIG. 1 illustrates an example in which a tool exchange device 10 according to the present embodiment is used as an apparatus in an industrial robot 1. The industrial robot 1 is installed on a base 8 parallel to an x-y plane, and a tool 16 is mounted on a distal end of an arm 12 via the tool exchange device 10. The industrial robot 1 has a configuration in which the arm 12 can be moved in an x direction, a y direction, and a z direction as a height direction which is a normal direction of the x-y plane, and the tool 16 mounted on the distal end of the arm 12 via the tool exchange device 10 can be moved to a desired position.

The tool exchange device 10 according to the present embodiment includes a first coupling unit 14a fixed to the distal end of the arm 12 of the industrial robot 1, which serves as a body, a first module unit 50a detachably fixed to the first coupling unit 14a, a second coupling unit 14b fixed to the tool 16, and a second module unit 50b detachably fixed to the second coupling unit 14b.

The first coupling unit 14a and the second coupling unit 14b respectively include plate-shaped coupling unit main bodies 13 and 15 formed of metal such as aluminum and having a predetermined thickness. The coupling unit body 13 of the first coupling unit 14a has a first coupling surface 20, and the coupling unit body 15 of the second coupling unit 14b has a second coupling surface 24. The first coupling unit 14a is coupled such that the first coupling surface 20 is in contact with the second coupling surface 24 of the second coupling unit 14b.

The first coupling unit 14a is detachably fastened to the distal end of the arm 12 by a bolt (not illustrated) on a first fixing surface 17 back-to-back with the first coupling surface 20. The first module unit 50a to which a cable 54 drawn from the industrial robot 1 or another peripheral device is connected is detachably fixed to the first coupling unit 14a on a side surface between the first coupling surface 20 and the first fixing surface 17. The first module unit 50a is provided with a first coupling connector 52 connectable to a second module unit 50b to be described later when the first coupling unit 14a and the second coupling unit 14b are coupled.

The second coupling unit 14b is detachably fastened to the tool 16 by a bolt (not illustrated) on a second fixing surface 19 back-to-back with the second coupling surface 24. The second module unit 50b is detachably fixed to the second coupling unit 14b on a side surface between the second coupling surface 24 and the second fixing surface 19. For example, one end of a cable 55 of which the other end is connected to the tool 16 is connected to the second module unit 50b. In addition, the second module unit 50b is provided at a position facing the first module unit 50a provided on the first coupling unit 14a so as to come into contact therewith when the first coupling unit 14a and the second coupling unit 14b are coupled.

The second module unit 50b is provided with a second coupling connector 53 connectable to the first coupling connector 52 of the first module unit 50a on a surface facing the first module unit 50a. In the first module unit 50a and the second module unit 50b, the first coupling connector 52 and the second coupling connector 53 are connected when the first coupling unit 14a and the second coupling unit 14b are coupled. The first coupling connector 52 and the second coupling connector 53 electrically connect the first module unit 50a and the second module unit 50b, for example.

When power is supplied from the industrial robot 1 or the peripheral device to the tool 16, power is supplied from the industrial robot 1 or the peripheral device to the first module unit 50a of the tool exchange device 10 via the cable 54, and power is also supplied from the first module unit 50a to the second module unit 50b via the first coupling connector 52 and the second coupling connector 53. Then, the tool exchange device 10 supplies the power supplied from the first module unit 50a to the second module unit 50b from the second module unit 50b to the tool 16 via the cable 55 to operate the tool 16.

FIG. 1 illustrates an example in which a spot welding gun is applied as the tool 16, and the spot welding gun can be operated by the power supplied from the tool exchange device 10 via the cable 55 to weld a workpiece (not illustrated). When various operations are performed using such an industrial robot 1, a plurality of different types of tools with the second coupling unit 14b attached thereto are prepared on a mounting table, which is not illustrated in FIG. 1.

In the tool exchange device 10, the first coupling unit 14a fixed to the arm 12 and the second coupling unit 14b fixed to the tool 16 are separated, and another second coupling unit to which another tool (not illustrated) is fixed is newly coupled to the first coupling unit 14a, so that the tool mounted on the arm 12 can be freely replaced in accordance with a work content.

Here, as the first module unit 50a and the second module unit 50b, for example, various module units provided with other connectors such as a power supply module unit provided with only a connector for power supply to which a cable is connected, a signal module unit provided with only a connector for signal, a servomotor module unit provided with a connector for power supply and a connector for signal, a water supply module unit provided with a connector for water supply to which a tube is connected instead of a cable, and a gas supply module unit provided with a connector for gas supply to which a tube is connected can be applied.

In this manner, the tool exchange device 10 uses the first module unit 50a and the second module unit 50b having optimum connectors in accordance with a type of the tool 16, so that power supply, signal transmission, water supply, air supply, and the like can be performed for the tool 16 via the first module unit 50a and the second module unit 50b.

In the present embodiment, an example in which a spot welding gun is applied as the tool 16 is illustrated, and therefore, the cables 54 and 55 capable of supplying power are connected to the tool exchange device 10, but as described above, for example, a cable for transmitting and receiving a control signal, or a tube through which a fluid such as air or water may be supplied is connected to the tool exchange device 10 instead of the cables 54 and 55 depending on the type of the tool. In this case, configurations of the first coupling connector 52 and the second coupling connector 53 are also appropriately changed to configurations such as signal pins and pipes.

### (2) Attachment Structure of Coupling Unit and Module Unit

In the above-described tool exchange device 10, an attachment structure of the first coupling unit 14a and the first module unit 50a and an attachment structure of the second coupling unit 14b and the second module unit 50b are the same attachment structure, and therefore, the attachment structure of the first coupling unit 14a and the first module unit 50a will be focused here and described below. In order to simplify the description, the first coupling unit 14a is simply referred to as the coupling unit 14a, and the first module unit 50a is simply referred to as the module unit 50a. As an example of the module unit 50a, a servomotor module unit provided with a connector for power supply and a connector for signal transmission will be described.

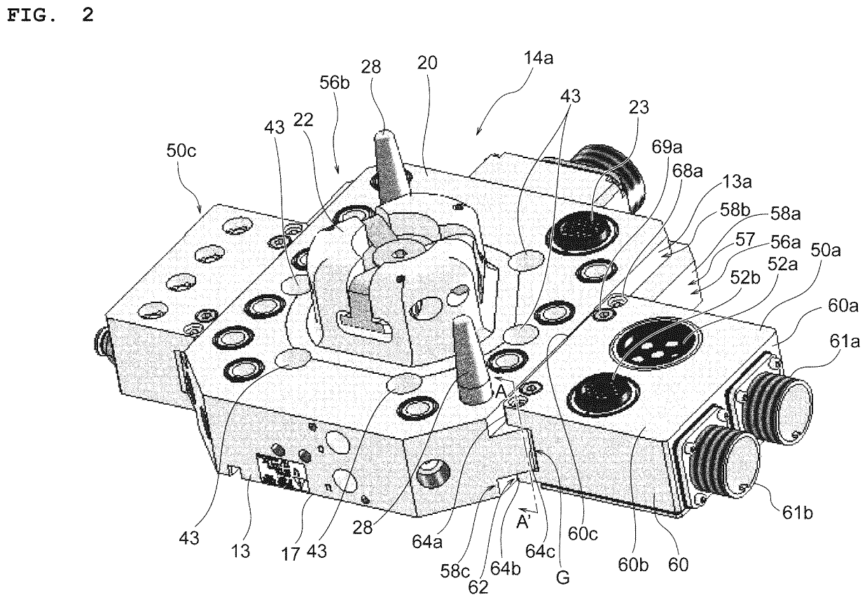

FIG. 2 is a schematic view illustrating a configuration when the module unit 50a is attached to the coupling unit 14a. The coupling unit 14a has a plate-shaped coupling unit body 13 having a predetermined thickness and a polygonal outer shape, and an engaging portion 22 projecting from the first coupling surface 20 is provided at a center of the coupling unit body 13. The engaging portion 22 has an engaging mechanism including a cam. In the coupling unit 14a, a plurality of positioning pins 28 projecting from the first coupling surface 20 are provided around the engaging portion 22. When being coupled to the second coupling unit 14b paired with the coupling unit 14a (hereinafter, simply referred to as another coupling unit), the plurality of positioning pins 28 are inserted into holes provided in the other coupling unit 14b to position the coupling unit 14a with respect to the other coupling unit 14b.

In addition, the coupling unit body 13 is provided with a connector (electrical block (core contact type electrical contact using spring contact pin)) 23 which is a plurality of signal pins at a predetermined position of the first coupling surface 20, and when being coupled to the other coupling unit 14b forming a pair, the connector 23 may be electrically connected to a connector of the other coupling unit 14b. When the coupling unit 14a is separated from the other coupling unit 14b, the connector 23 is disconnected from the connector of the other coupling unit 14b.

The coupling unit 14a is provided with a plurality of through holes 43 into which bolts (not illustrated) for fixing to the distal end of the arm 12 are inserted. The coupling unit 14a is formed with a module attachment portion 56a on a side surface 13a disposed between the first coupling surface 20 and the first fixing surface 17 of the coupling unit body 13, and is provided with the module unit 50a via the module attachment portion 56a. In FIG. 2, in addition to the module unit 50a being attached to the module attachment portion 56a provided on the side surface 13a of the coupling unit body 13, another module unit 50c is also attached to the module attachment portion 56b provided on another side surface of the coupling unit body 13.

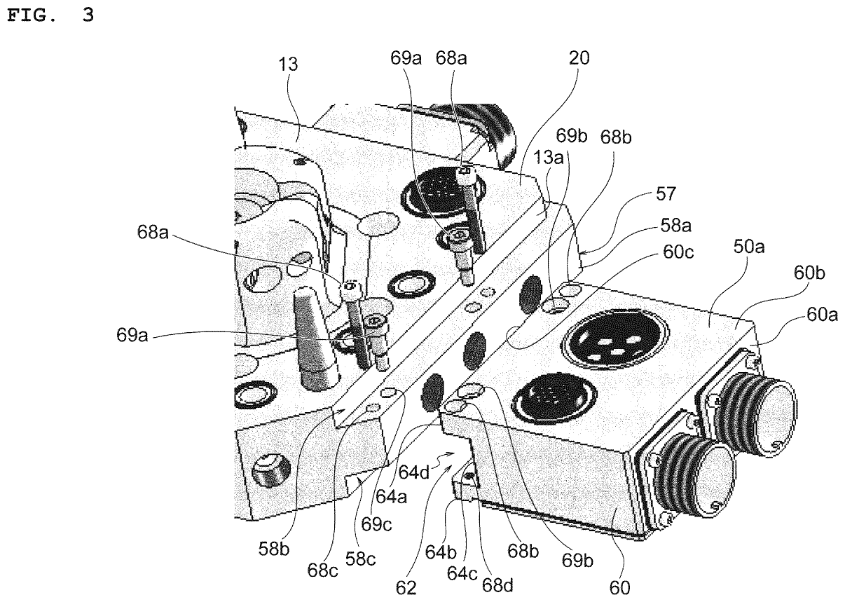

Since the module attachment portions 56a and 56b have the same configuration, the module attachment portion 56a will be focused here and described below. FIG. 3 is a schematic view illustrating a configuration when the module unit 50a is detached from the coupling unit 14a. As illustrated in FIGS. 2 and 3, the module attachment portion 56a is provided with a first fitting portion 57 having a projecting cross section whose longitudinal direction extends in the circumferential direction of the side surface 13a of the coupling unit body 13, and a through hole 68c and an insertion hole 69c (FIG. 3) through which a bolt 68a or a shoulder bolt 69a to be described later is inserted.

The first fitting portion 57 includes a plate-shaped projecting portion 58a having a rectangular cross section whose longitudinal direction extends in the circumferential direction of the side surface 13a of the coupling unit body 13, and stepped portions 58b and 58c parallel to the circumferential direction with the projecting portion 58a sandwiched in the thickness direction of the coupling unit body 13 orthogonal to the circumferential direction. The through hole 68c is bored in the projecting portion 58a so as to penetrate through the thickness of the projecting portion 58a, and is formed such that the bolt 68a may be inserted thereinto. The insertion hole 69c is bored in the projecting portion 58a in a state of not penetrating through the thickness of the projecting portion 58a, and is formed such that the shoulder bolt 69a may be inserted thereinto.

Next, the configuration of the module unit 50a will be described. FIG. 2 illustrates an example in which a servomotor module unit provided with a connector 61a for power supply to a motor, a coupling connector 52a, a connector 61b for signal transmission, and a coupling connector 52b is applied as the module unit 50a. The module unit 50a includes a rectangular module unit body 60 having a predetermined thickness, and the connector 61a for power supply, the coupling connector 52a, the connector 61b for signal transmission, and the coupling connector 52b are provided at predetermined positions of the module unit body 60. In FIG. 2, the first coupling connector 52 illustrated in FIG. 1 is illustrated as the coupling connector 52a for power supply and the coupling connector 52b for signal transmission.

The connectors 61a and 61b are provided, for example, on a side surface 60a facing a second fitting portion 62 to be described later, and for example, a cable for power supply or a signal cable connected to a peripheral device (not illustrated) is connected as the cable 54 in FIG. 1. The module unit 50a is connected to a peripheral device via the cable 54 by the connectors 61a and 61b, and may receive power supply and control signals from the peripheral device.

The coupling connectors 52a and 52b are provided on a coupling surface 60b facing the other module unit 50b attached to the other coupling unit 14b. When the coupling unit 14a to which the module unit 50a is attached and the coupling unit 14b to which the other module unit 50b is attached are coupled, the coupling connectors 52a and 52b are electrically connected to the corresponding coupling connector for power supply and the coupling connector for signal reception (second coupling connector 53 illustrated in FIG. 1) of the other module unit 50b attached to the other coupling unit 14b, respectively. When the coupling unit 14a is separated from the other coupling unit 14b, the coupling connectors 52a and 52b are disconnected from the second coupling connector 53 of the other module unit 50b.

The module unit body 60 is formed with the second fitting portion 62 having a recessed cross section that may be fitted into the first fitting portion 57 on a side surface 60c attached to the coupling unit 14a. The second fitting portion 62 includes a plate-shaped first projecting end portion 64a and a plate-shaped second projecting end portion 64b whose longitudinal directions are parallel to the circumferential direction of the side surface 60c of the module unit body 60, and a groove 64c extending in the circumferential direction and sandwiched between the first projecting end portion 64a and the second projecting end portion 64b in the thickness direction of the module unit body 60 orthogonal to the circumferential direction.

In the second fitting portion 62, a hollow portion 64d (FIG. 3) of the groove 64c sandwiched between the first projecting end portion 64a and the second projecting end portion 64b which are parallel is formed to have a quadrilateral cross section in accordance with an outer shape of the projecting portion 58a having a quadrilateral cross section of the first fitting portion 57. Accordingly, in the second fitting portion 62, the projecting portion 58a of the first fitting portion 57 may be fitted into the hollow portion 64d of the groove 64c sandwiched between the first projecting end portion 64a and the second projecting end portion 64b. In the present embodiment, when the second fitting portion 62 is fitted into the first fitting portion 57, a gap G is formed between a bottom surface of the groove 64c and a distal end surface of the projecting portion 58a of the first fitting portion 57. In this manner, by forming the gap G between the bottom surface of the groove 64c and the distal end surface of the projecting portion 58a of the first fitting portion 57, when an external load is applied to the module unit body 60, it is possible to prevent the external load from being directly applied from the module unit body 60 to the distal end surface of the projecting portion 58a of the first fitting portion 57.

The first projecting end portion 64a and the second projecting end portion 64b are plate-shaped projections having a thickness, and are formed such that, when the projecting portion 58a of the first fitting portion 57 is fitted into the groove 64c, an inner surface facing the first projecting end portion 64a and the second projecting end portion 64b abuts against an outer surface facing the projecting portion 58a of the first fitting portion 57. Accordingly, when the second fitting portion 62 is fitted into the first fitting portion 57, the projecting portion 58a of the first fitting portion 57 is sandwiched and held between the first projecting end portion 64a and the second projecting end portion 64b in the thickness direction of the coupling unit body 13 and the module unit body 60.

The first projecting end portion 64a is provided with through holes 68b and 69b (FIG. 3) through which the bolt 68a or the shoulder bolt 69a to be described later is inserted so as to penetrate the thickness. The through holes 68b and 69b formed in the first projecting end portion 64a are bored at positions penetrating the through hole 68c and the insertion hole 69c of the first fitting portion 57, respectively, when the second fitting portion 62 is fitted into the first fitting portion 57. In addition, the second projecting end portion 64b is provided with a threaded hole 68d (FIG. 3) into which the bolt 68a inserted into the through holes 68b and 68c is screwed so as to penetrate the thickness.

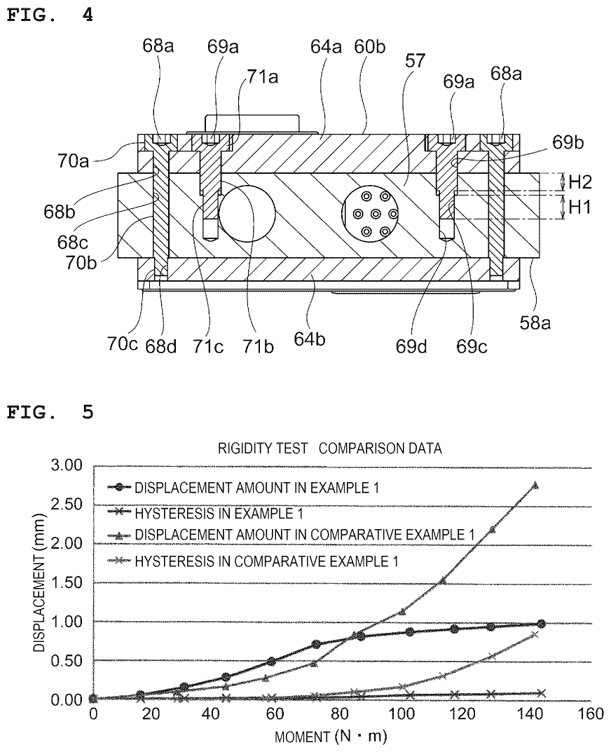

Here, FIG. 4 is a cross-sectional view illustrating a cross-sectional configuration of an A-A′ portion in FIG. 2 illustrating the configuration when the module unit 50a is attached to the coupling unit 14a. As illustrated in FIGS. 2, 3, and 4, when the second fitting portion 62 is fitted into the first fitting portion 57, the bolt 68a is sequentially inserted into the through hole 68b bored in the first projecting end portion 64a of the second fitting portion 62, the through hole 68c bored in the projecting portion 58a of the first fitting portion 57, and the threaded hole 68d bored in the second projecting end portion 64b of the second fitting portion 62, and penetrates the first projecting end portion 64a of the second fitting portion 62, the projecting portion 58a of the first fitting portion 57, and the second projecting end portion 64b of the second fitting portion 62. Accordingly, the bolt 68a fixes the first fitting portion 57 and the second fitting portion 62 which are fitted into each other.

Here, the bolt 68a includes a head portion 70a, a thread portion 70b continuous to the head portion 70a, and a thread portion 70c at a distal end having a smaller diameter than the thread portion 70b and continuous to the thread portion 70b, as illustrated in FIG. 4. The head portion 70a and the thread portion 70b of the bolt 68a are inserted into the through hole 68b at the first projecting end portion 64a, the thread portion 70b of the bolt 68a is inserted into the through hole 68c at the projecting portion 58a, and the thread portion 70c of the bolt 68a is screwed into the threaded hole 68d at the second projecting end portion 64b.

When the second fitting portion 62 is fitted into the first fitting portion 57, the shoulder bolt 69a is sequentially inserted into the through hole 69b bored in the first projecting end portion 64a of the second fitting portion 62 and the insertion hole 69c bored in the projecting portion 58a of the first fitting portion 57, and penetrates the first projecting end portion 64a of the second fitting portion 62 and the projecting portion 58a of the first fitting portion 57. Accordingly, the shoulder bolt 69a fixes the first fitting portion 57 and the second fitting portion 62 which are fitted into each other.

The shoulder bolt 69a includes a head portion 71a, a columnar or cylindrical fitting trunk portion 71b continuous to the head portion 71a, and a thread portion 71c at a distal end having a smaller diameter than the fitting trunk portion 71b and continuous to the fitting trunk portion 71b. The head portion 71a and the fitting trunk portion 71b of the shoulder bolt 69a are inserted into the through hole 69b at the first projecting end portion 64a, the fitting trunk portion 71b of the shoulder bolt 69a is inserted into a fitting region of the insertion hole 69c at the projecting portion 58a, and the thread portion 71c of the shoulder bolt 69a is screwed into a screwing region of the insertion hole 69c.

In the module unit 50a, the second fitting portion 62 can be accurately positioned on the first fitting portion 57 by the fitting trunk portion 71b using the shoulder bolt 69a provided with the fitting trunk portion 71b. Accordingly, in the module unit 50a, the second fitting portion 62 can be accurately positioned on the first fitting portion 57 by the shoulder bolt 69a without providing the positioning pin 121 in the related art (FIG. 6), and therefore, the positioning pin 121 can be eliminated. In addition, the second fitting portion 62 can be accurately positioned on the first fitting portion 57 only by screwing the shoulder bolt 69a, and therefore, the module unit 50a can be easily attached to and detached from the coupling unit 14a.

The shoulder bolt 69a according to the present embodiment is selected such that a screwing length H1 of the thread portion 71c at the projecting portion 58a of the first fitting portion 57 is larger than a fitting length H2 of the fitting trunk portion 71b at the projecting portion 58a of the first fitting portion 67. In this manner, in the present embodiment, a portion where the first fitting portion 57 and the second fitting portion 62 are fixed by the shoulder bolt 69a is selected such that screwing length H1 >fitting length H2, and therefore, the ease of removal of the shoulder bolt 69a from the first fitting portion 57 and the second fitting portion 62 is improved, and the fixing work when the first fitting portion 57 and the second fitting portion 62 are fitted and fixed by the shoulder bolt 69a can be easily performed.

### (3) Operation and Effect

The tool exchange device 10 according to the present embodiment has a configuration in which the first coupling unit 14a attached to an arm 12 side of the industrial robot 1, which serves as a body of an apparatus, and the second coupling unit 14b attached to a tool 16 side may be coupled, and the module attachment portion 56a is provided on a side surface of each of the coupling unit main bodies 13 and 15 of the first coupling unit 14a and the second coupling unit 14b. The first module unit 50a is detachably attached to the module attachment portion 56a of the first coupling unit 14a, and the second module unit 50b is detachably attached to the module attachment portion 56a of the second coupling unit 14b.

In such a configuration, the module attachment portion 56a is provided with the first fitting portion 57 having a projecting cross section and extending in the circumferential direction along the side surfaces of the coupling unit main bodies 13 and 15, and the first module unit 50a and the second module unit 50b are provided with the second fitting portion 62 having a recessed cross section that may be fitted into the first fitting portion 57.

Accordingly, for example, when the first module unit 50a is attached to the coupling unit body 13, the second fitting portion 62 having a recessed cross section sandwiches the first fitting portion 57 having a projecting cross section of the module attachment portion 56a in the thickness direction orthogonal to the circumferential direction of the coupling unit body 13, and the second fitting portion 62 is fitted into the first fitting portion 57. Further, the first module unit 50a is fixed to the side surface of the coupling unit body 13 with a plurality of bolts 68a and shoulder bolts 69a penetrating the first fitting portion 57 and the second fitting portion 62 which are fitted into each other.

In this manner, in the tool exchange device 10, the first fitting portion 57 and the second fitting portion 62 may be sandwiched in the thickness direction, so that for example, the coupling unit body 13 and the first module unit 50a can be fixed to each other more firmly than a cantilever structure in the related art. Accordingly, in the tool exchange device 10, when the first module unit 50a is fixed to the coupling unit body 13, for example, even when an external load is applied to the first module unit 50a, the external load is not concentrated only on the cantilever projecting portion 105 (FIG. 6) unlike the cantilever structure in the related art, and the external load can be dispersed at the fixing portion of the first fitting portion 57 and the second fitting portion 62. Accordingly, in the tool exchange device 10, when the first module unit 50a is fixed to the coupling unit body 13, it is possible to suppress damage to a fixing portion due to an external load as compared with the related art.

In addition, in the tool exchange device 10, the first fitting portion 57 and the second fitting portion 62 may be sandwiched in the thickness direction, so that the first fitting portion 57 and the second fitting portion 62 can be firmly fixed to each other even when a size of the projecting portion 58a of the first fitting portion 57 having a projecting cross section and a projecting region of the first projecting end portion 64a and the second projecting end portion 64b of the second fitting portion 62 having a recessed cross section is suppressed as compared with the cantilever structure in the related art. Therefore, the fixing portion for fixing the first module unit 50a to the module attachment portion 56a of the coupling unit body 13 can be reduced in size, and the first module unit 50a itself can be reduced in size. In addition, in the tool exchange device 10, the first module unit 50a can be reduced in weight because the first module unit 50a can be reduced in size.

The second coupling unit 14b and the second module unit 50b can be fixed by the first fitting portion 57 and the second fitting portion 62, similar to the attachment structure of the first coupling unit 14a and the first module unit 50a, and therefore, the same effects as those of the attachment structure of the first coupling unit 14a and the first module unit 50a can be exerted.

### (4) Verification Test

Next, a rigidity test is performed using, as an attachment structure of Example 1, an attachment structure in which the second fitting portion 62 having a recessed cross section of the module unit 50a sandwiches the first fitting portion 57 having a projecting cross section provided in the module attachment portion 56a of the coupling unit 14a in the thickness direction of the coupling unit 14a and the first fitting portion 57 and the second fitting portion 62, which are fitted into each other, are fixed by two bolts 68a and two shoulder bolts 69a, as illustrated in FIGS. 2 to 4.

In addition, a rigidity test is performed using, as an attachment structure of Comparative Example 1, an attachment structure in the related art in which the module unit 104 is held in a cantilever structure by the cantilever projecting portion 105 provided on the module attachment portion 102 of the coupling unit 100 and the module unit 104 is fixed to the cantilever projecting portion 105 by four bolts 110, as illustrated in FIG. 6.

In the rigidity test, the coupling unit 14a has the same configuration as the coupling unit 100 of Comparative Example 1 except for the configuration of the module attachment portion 56a, in order to confirm the rigidity depending on a difference between the attachment structures of Example 1 and Comparative Example 1. In addition, the module unit 50a also has the same configuration as the module unit 104 of Comparative Example 1 except for the configuration of the second fitting portion 62.

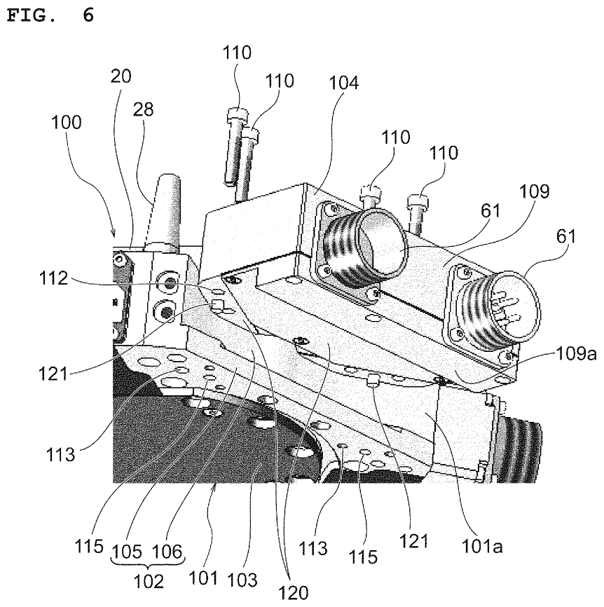

In the rigidity test, a moment is applied to each of the module unit 50a of Example 1 and the module unit 104 of Comparative Example 1 in the thickness direction in a state where the coupling units 14a and 100 are fixed, and the displacement of each of the module unit 50a of Example 1 and the module unit 104 of Comparative Example 1 in the thickness direction is measured. As a result, results as illustrated in FIG. 5 are obtained.

The “displacement amount in Example 1” in FIG. 5 indicates a measurement result obtained by measuring a displacement position in the thickness direction of an upper surface of the module unit 50a with a laser displacement meter when a distal end side of the module unit 50a is pulled upward and a predetermined moment is applied to the module unit 50a in the thickness direction. The “hysteresis in Example 1” in FIG. 5 indicates a measurement result obtained by measuring a displacement position in the thickness direction of the upper surface of the module unit 50a with a laser displacement meter after pulling the distal end side of the module unit 50a upward and applying a predetermined moment to the module unit 50a in the thickness direction and then stopping applying the moment.

The “displacement amount in Comparative Example 1” in FIG. 5 indicates a measurement result obtained by measuring a displacement position in the thickness direction of the upper surface of the module unit 104 with a laser displacement meter when the distal end side of the module unit 104 is pulled upward and a predetermined moment is applied to the module unit 104 in the thickness direction. The “hysteresis in Comparative Example 1” in FIG. 5 indicates a measurement result obtained by measuring the displacement position in the thickness direction of the upper surface of the module unit 104 with a laser displacement meter after pulling the distal end side of the module unit 104 upward and applying a predetermined moment to the module unit 104 in the thickness direction and then stopping applying the moment.

In FIG. 5, a horizontal axis represents the moment, and a vertical axis represents a displacement of a formed gap. It is confirmed from FIG. 5 that in the attachment structure of Example 1, the displacement when the moment is applied and the displacement after the moment is applied are smaller than those in the attachment structure of Comparative Example 1. Accordingly, the attachment structure of Example 1 can suppress damage to a fixing portion due to an external load more than the attachment structure of Comparative Example 1 in the related art.

### (5) Other Embodiments

In the above-described embodiment, a case has been described in which the first coupling unit 14a is attached to the arm 12 side of the industrial robot 1 which is the body side of the apparatus and the second coupling unit 14b is attached to the tool 16, but the present invention is not limited thereto, the second coupling unit 14b may be attached to the arm 12 side of the industrial robot 1 which is the body side of the apparatus, and the first coupling unit 14a may be attached to the tool 16.

In addition, in the above-described embodiment, the tool exchange device 10 has been described in which the first fitting portion 57 is provided on each of the side surfaces of the coupling unit main bodies 13 and 15 of the first coupling unit 14a and the second coupling unit 14b, and the second fitting portion 62 of each of the first module unit 50a and the second module unit 50b is fitted into the corresponding first fitting portion 57 of the first coupling unit 14a and the second coupling unit 14b, but the present invention is not limited thereto. For example, the first fitting portion 57 may be provided only on the side surface of the coupling unit body 13 of either the first coupling unit 14a or the second coupling unit 14b, for example, and the other coupling unit body may have a cantilever structure using the cantilever projecting portion 105 in the related art. In this case, only the first module unit 50a attached to the one coupling unit body 13 is provided with the second fitting portion 62 that may be fitted into the first fitting portion 57.

In the above-described embodiment, a case has been described in which the first fitting portion 57 provided on the side surface of the coupling unit body 13 has a projecting cross section, and the second fitting portion 62 provided on each of the first module unit 50a and the second module unit 50b has a recessed cross section, but the present invention is not limited thereto. For example, the first fitting portion 57 provided on the side surface of the coupling unit body 13 may have a recessed cross section, the second fitting portion 62 provided on the first module unit 50a and the second module unit 50b may have a projecting cross section, and the first fitting portion 57 may sandwich the second fitting portion 62 in the thickness direction. In this manner, even when the first fitting portion 57 and the second fitting portion 62 are reversed in the projecting cross section and the recessed cross section, the same effects as those of the above-described embodiment can be exerted.

In addition, in the above-described embodiment, a case has been described in which the bolt 68a and the shoulder bolt 69a are applied as the plurality of pins penetrating the first fitting portion and the second fitting portion which are fitted into each other, but the present invention is not limited thereto, for example, a shoulder bolt may be applied instead of the bolt 68a, and a first fitting portion and a second fitting portion may be fixed using only the shoulder bolt, or a bolt may be applied instead of the shoulder bolt 69a, and the first fitting portion and the second fitting portion may be fixed using only the bolt.

In the above-described embodiment, a case has been described in which the first fitting portion 57 having a projecting cross section and extending in the circumferential direction from one end to the other end of the side surface 13a of the coupling unit body 13 is applied as the first fitting portion having a projecting cross section or a recessed cross section and extending in the circumferential direction along the side surface of the coupling unit body, and is fitted into the second fitting portion 62 of the module unit 50a on the entire side surface 13a, but the present invention is not limited thereto. For example, a first fitting portion having a projecting section or a recessed cross section and extending in the circumferential direction may be provided only in a partial region of the side surface 13a of the coupling unit body 13, and may be fitted into a second fitting portion having a recessed cross section or a projecting cross section provided in a module unit only in a partial region of the side surface 13a.

### REFERENCE SIGN LIST

1 industrial robot (apparatus)
10 tool exchange device
12 arm (body)
13, 15 coupling unit body
14a first coupling unit (coupling unit)
14b second coupling unit (coupling unit)
16 tool
50a first module unit (module unit)
50b second module unit (module unit)
57 first fitting portion
61a, 61b connector
62 second fitting portion
68a bolt (pin)
69a shoulder bolt (pin)

1. A tool exchange device comprising:
a first coupling unit to be attached to either a body side or a tool side of an apparatus;
a second coupling unit to be attached to the other of the body side and the tool side and configured to be coupled to the first coupling unit;
a module attachment portion provided on a side surface of a coupling unit body of at least one of the first coupling unit and the second coupling unit; and
a module unit provided with a connector to which a cable or a tube is connectable and detachably attached to the side surface of the coupling unit body via the module attachment portion, wherein
the module attachment portion includes a first fitting portion having a projecting cross section or a recessed cross section and extending in a circumferential direction along the side surface of the coupling unit body, and
the module unit includes a second fitting portion having a recessed cross section or a projecting cross section and configured to be fitted into the first fitting portion, and is fixed to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and making a plurality of pins penetrate the first fitting portion and the second fitting portion which are fitted into each other.

2. The tool exchange device according to claim 1, wherein
the first fitting portion or the second fitting portion having the recessed cross section sandwiches and holds, in the thickness direction of the coupling unit body, a plate-shaped projecting portion of the second fitting portion or the first fitting portion having the projecting cross section, which extends in the circumferential direction of the coupling unit body, by a plate-shaped first projecting end portion and a plate-shaped second projecting end portion extending in the circumferential direction of the coupling unit body.

3. The tool exchange device according to claim 1, wherein
the plurality of pins include a shoulder bolt, and
the module unit is positioned with respect to the module attachment portion by the shoulder bolt.

4. The tool exchange device according to claim 3, wherein
the shoulder bolt includes a head portion, a columnar or cylindrical fitting trunk portion continuous to the head portion, and a thread portion having a smaller diameter than the fitting trunk portion and continuous to the fitting trunk portion,
the fitting trunk portion penetrates the first fitting portion and the second fitting portion, and
the thread portion is screwed into the first fitting portion or the second fitting portion having the projecting cross section which is sandwiched by the second fitting portion or the first fitting portion having the recessed cross section.

5. The tool exchange device according to claim 4, wherein the shoulder bolt is selected such that a screwing length of the thread portion in the first fitting portion or the second fitting portion having the projecting cross section is larger than a fitting length of the fitting trunk portion in the first fitting portion or the second fitting portion having the projecting cross section.

6. A coupling unit of a tool exchange device, the coupling unit having a configuration capable of being coupled to a coupling unit to be attached to either a body side or a tool side of an apparatus, and being to be attached to the other of the body side and the tool side, the coupling unit comprising:
a coupling unit body; and
a module attachment portion provided on a side surface of the coupling unit body and configured to detachably attach, to the side surface of the coupling unit body, a module unit provided with a connector to which a cable or a tube is connectable, wherein
the module attachment portion includes a first fitting portion having a projecting cross section or a recessed cross section and extending in a circumferential direction along the side surface of the coupling unit body, the first fitting portion having a configuration capable of being fitted into a second fitting portion having a recessed cross section or a projecting cross section and provided in the module unit, and the module attachment portion fixes the module unit to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and making a plurality of pins penetrate the first fitting portion and the second fitting portion which are fitted into each other.

7. A module unit of a tool exchange device that includes a first coupling unit to be attached to either a body side or a tool side of an apparatus, and a second coupling unit to be attached to the other of the body side and the tool side and configured to be coupled to the first coupling unit, the module unit being detachably attached to a side surface of a coupling unit body of at least one of the first coupling unit and the second coupling unit, the module unit comprising:
a module unit body detachably attached to the side surface of the coupling unit body via a module attachment portion provided on the side surface of the coupling unit body and provided with a connector to which a cable or a tube is connectable, wherein
the module unit body includes a second fitting portion having a projecting cross section or a recessed cross section that is fittable with respect to a first fitting portion having a projecting cross section or a recessed cross section, the first fitting portion being provided on the module attachment portion and extending in a circumferential direction along the side surface of the coupling unit body, and the module unit body is fixed to the side surface of the coupling unit body by the first fitting portion or the second fitting portion having the recessed cross section sandwiching the second fitting portion or the first fitting portion having the projecting cross section in a thickness direction orthogonal to the circumferential direction of the coupling unit body and making a plurality of pins penetrate the first fitting portion and the second fitting portion which are fitted into each other.
